(19) United States
(12) Patent Application Publication
(10) Pub. No.: US 2017/0158463 A1
(43) Pub. Date: Jun. 8, 2017

(54) CLEANING DEVICE FOR GUIDE RAIL OF ELEVATOR AND CLEANING METHOD THEREOF

(71) Applicant: Otis Elevator Company, Farmington, CT (US)

(72) Inventors: Fan Jiang, Tianjin (CN); Shengyu Wang, Tianjin (CN); Hai Dong, Tianjin (CN); Zhixue Li, Tianjin (CN)

(21) Appl. No.: 15/363,708

(22) Filed: Nov. 29, 2016

(30) Foreign Application Priority Data
Dec. 2, 2015 (CN) 201510867956.6

(51) Int. Cl. B66B 7/12; B08B 3/08; B08B 1/00

(52) U.S. Cl. CPC B66B 7/1292; B08B 1/005; B08B 1/006; B08B 3/08

(57) ABSTRACT

The present invention provides an elevator guide rail cleaning apparatus and a cleaning method using the same, which belongs to the technical field of elevators. The elevator guide rail cleaning apparatus according to the present invention includes: a base, a scraping component installed opposite to an operating surface of an elevator guide rail, and a wiping component installed opposite to the operating surface of the elevator guide rail, wherein the elevator guide rail cleaning apparatus is detachably installed on a guide apparatus of an elevator system. The elevator guide rail cleaning apparatus according to the present invention can effectively remove foreign matters such as anti-rust coatings on an elevator guide rail, which has high cleaning efficiency, good cleaning effects, high automatic cleaning degree and low labor intensity.

### PRIORITY

This application claims priority to Chinese Patent Application No. 201510867956.6, filed Dec. 2, 2015, and all the benefits accruing therefrom under 35 U.S.C. §119, the contents of which in its entirety are herein incorporated by reference.

### TECHNICAL FIELD

The present invention relates to the technical field of elevators, relates to the cleaning and maintenance of elevator guide rails, and in particular to an elevator guide rail cleaning apparatus capable of automatically cleaning and removing foreign matters such as anti-rust coatings on an elevator guide rail and a method for cleaning an elevator guide rail by using the elevator guide rail cleaning apparatus.

### BACKGROUND

Cars in elevator systems are driven to lift in elevator hoistways along guide rails thereof. In order to guide cars along guide rails, guide apparatuses such as guide shoes are provided on cars of elevator systems.

Elevator guide rails, as one of critical components in elevator systems, have to keep their operating surfaces clean during the lifting movement of cars along their guide rails. Thus, cleaning apparatuses are needed for cleaning foreign matters. Moreover, elevator guide rails also need to be maintained such as rust prevention, especially before the elevator systems are set into service (e.g. from leaving factory to installation of elevator systems), during which stage, the operating surfaces of the elevator guide rails may have been not used for a relatively long time and thick anti-rust coatings (such as anti-rust oil) need to be coated on the operating surfaces of the elevator guide rails to protect the elevator guide rails from rust.

Thus, the cleaning of elevator guide rails includes removing the anti-rust coatings on the operating surfaces before the normal operation of elevator systems.

Since the anti-rust coatings are usually highly viscous and thick and difficult to remove, in the prior art, foreign matters such as anti-rust coatings are usually removed manually by workers during the installation of elevator systems, which is not only time-consuming and labor-intensive but also requires to work in the elevator hoistways and thus has serious labor intensity, low efficiency and some risk.

A cleaning apparatus disclosed in application No. CN201020637950.2 entitled “Automatic cleaning apparatus for elevator guide rail” is that a brush is integrally installed onto a guide shoe and the brush acts on an operating surface of a guide rail. Such a cleaning apparatus can merely remove foreign matters which are easy to remove such as dust on the guide rail surface, and the like, and can be merely applied to simple cleaning and maintenance of elevator systems during normal operation and cannot be applied to cleaning and removing of foreign matters such as anti-rust coatings on elevator guide rails. Other elevator guide rail cleaning apparatuses in the prior art cannot automatically clean and remove foreign matters such as anti-rust coatings on elevator guide rails either.

### SUMMARY

An object of the present invention is to provide an elevator guide rail cleaning apparatus capable of automatically cleaning foreign matters such as an anti-rust coating on an elevator guide rail.

Another object of the present invention is to provide an elevator guide rail cleaning method capable of automatically cleaning foreign matters such as an anti-rust coating on an elevator guide rail.

In order to achieve the above objects and other objects, the present invention provides the following technical solution.

According to an aspect of the present invention, an elevator guide rail cleaning apparatus is provided, including:

a base;

a scraping component installed opposite to an operating surface of an elevator guide rail; and

a wiping component installed opposite to the operating surface of the elevator guide rail;

wherein the elevator guide rail cleaning apparatus is detachably installed on a guide apparatus of an elevator system.

In the elevator guide rail cleaning apparatus according to an embodiment of the present invention, wherein, the base is provided with a first installation part and a second installation part, the scraping component is detachably installed on the first installation part, and the wiping component is detachably installed on the second installation part.

In the elevator guide rail cleaning apparatus according to an embodiment of the present invention, wherein, the apparatus further includes a pressure component for the scraping component to bias a certain pressure to the operating surface of the elevator guide rail.

In the elevator guide rail cleaning apparatus according to an embodiment of the present invention, wherein, the pressure component includes a spring and a plug, wherein the spring is placed in a positioning cylinder provided on the first installation part and causes a first end of the spring to apply a pressure to the scraping component and a second end of the spring to abut the plug fixed on the positioning cylinder.

In the elevator guide rail cleaning apparatus according to an embodiment of the present invention, wherein, the scraping component is mainly made of polyformaldehyde resin (POM) and integrally formed.

In the elevator guide rail cleaning apparatus according to an embodiment of the present invention, wherein, the scraping component includes a scraping plate and a scraping bar provided on the scraping plate in a projection manner.

In the elevator guide rail cleaning apparatus according to an embodiment of the present invention, wherein, there are three or more scraping bars and a plurality of scraping bars are disposed perpendicularly relative to a length direction of the elevator guide rail.

In the elevator guide rail cleaning apparatus according to an embodiment of the present invention, wherein, an operating surface of the scraping plate is provided with a plurality of accommodation grooves.

In the elevator guide rail cleaning apparatus according to an embodiment of the present invention, wherein, each of the accommodation grooves is provided between adjacent scraping bars.

In the elevator guide rail cleaning apparatus according to an embodiment of the present invention, wherein, the width of the accommodation groove is 10 mm to 50 mm.

In the elevator guide rail cleaning apparatus according to an embodiment of the present invention, wherein, there are two scraping components and the two scraping components are installed opposite to each other.

In the elevator guide rail cleaning apparatus according to an embodiment of the present invention, wherein, the wiping component is mainly made of felt.

In the elevator guide rail cleaning apparatus according to an embodiment of the present invention, wherein, the wiping component is square-shaped.

In the elevator guide rail cleaning apparatus according to an embodiment of the present invention, wherein, there are two wiping components and the two wiping components are installed opposite to each other.

In the elevator guide rail cleaning apparatus according to an embodiment of the present invention, wherein, the apparatus further includes a cleaning liquid supply apparatus for supplying a cleaning liquid to the wiping component.

In the elevator guide rail cleaning apparatus according to an embodiment of the present invention, wherein, the cleaning liquid supply apparatus includes:

a cleaning liquid container fixed on the base and located above the wiping component;

a liquid flow pipe for guiding the cleaning liquid in the cleaning liquid container to the wiping component; and

a siphon component provided at one side of the liquid flow pipe close to the wiping component.

In the elevator guide rail cleaning apparatus according to an embodiment of the present invention, wherein, the guide apparatus is a guide shoe installed underneath a car of the elevator system.

In the elevator guide rail cleaning apparatus according to an embodiment of the present invention, wherein, the wiping component is located underneath the scraping component.

In the elevator guide rail cleaning apparatus according to an embodiment of the present invention, wherein, the apparatus further includes installation supports for detachably installing the base on the guide shoe.

According to another aspect of the present invention, a method for cleaning an elevator guide rail by using the above elevator guide rail cleaning apparatus is provided, including the following steps:

step 1: installing the elevator guide rail cleaning apparatus on a guide apparatus of an elevator system;

step 2: running the elevator system to cause the elevator guide rail cleaning apparatus and the guide apparatus to move relative to the elevator guide rail synchronously, cause the scraping component to scrape and remove an anti-rust coating on an operating surface of the elevator guide rail, and cause the wiping component to wipe the operating surface of the elevator guide rail; and

step 3: detaching and removing the elevator guide rail cleaning apparatus.

In the method for cleaning an elevator guide rail according to an embodiment of the present invention, wherein, in step 2, a cleaning liquid is supplied to the wiping component to dissolve the anti-rust coating.

In the method for cleaning an elevator guide rail according to an embodiment of the present invention, wherein, in step 2, the guide apparatus moves upwards from the bottom of an elevator hoistway.

In the method for cleaning an elevator guide rail according to an embodiment of the present invention, wherein, the method for cleaning an elevator guide rail is carried out during the installation of the elevator system.

According to still another aspect of the present invention, a scraping component used in any of the elevator guide rail cleaning apparatus above is provided.

According to yet another aspect of the present invention, a wiping component used in any of the elevator guide rail cleaning apparatus above is provided.

The elevator guide rail cleaning apparatus according to the present invention has high automatic cleaning degree and low labor intensity, and can effectively remove foreign matters such as anti-rust coatings on an elevator guide rail through dual cleaning in combination with a scraping component and a wiping component, which has high cleaning efficiency and good cleaning effects. Moreover, the elevator guide rail cleaning apparatus may be repeatedly installed and used in different elevator systems.

### BRIEF DESCRIPTION OF THE DRAWINGS

The above and other objects and advantages of the present invention will be more complete and clear from the following detailed description in conjunction with the accompanying drawings, in which the same or similar elements adopt the same reference numerals.

FIG. 1 is a perspective schematic structural diagram of an elevator guide rail cleaning apparatus according to an embodiment of the present invention.

FIG. 2 is a front view of an elevator guide rail cleaning apparatus according to an embodiment of the present invention.

FIG. 3 is a side view of an elevator guide rail cleaning apparatus according to an embodiment of the present invention.

FIG. 4 is a perspective schematic structural diagram of a base body of the elevator guide rail cleaning apparatus shown in FIG. 1.

FIG. 5 is a front view of the base body shown in FIG. 4.

FIG. 6 is a perspective schematic structural diagram of a scraping component of the elevator guide rail cleaning apparatus shown in FIG. 1.

FIG. 7 is a perspective schematic structural diagram of a wiping component of the elevator guide rail cleaning apparatus shown in FIG. 1.

FIG. 8 is a schematic structural diagram of an elevator guide rail cleaning apparatus according to an embodiment of the present invention being provided with an exemplary installation support for installing the same on a guide shoe.

FIG. 9 is a schematic structural diagram of an elevator guide rail cleaning apparatus according to an embodiment of the present invention being provided with another exemplary installation support for installing the same on a guide shoe.

FIG. 10 is a schematic structural diagram of an elevator guide rail cleaning apparatus according to an embodiment of the present invention being provided with still another exemplary installation support for installing the same on a guide shoe.

FIG. 11 is a schematic process diagram of a cleaning method using an elevator guide rail cleaning apparatus according to an embodiment of the present invention.

### DETAILED DESCRIPTION

Some of the possible embodiments of the present invention are introduced hereinafter, which are intended to provide a basic understanding of the present invention rather than determining critical or decisive elements of the present invention or defining the scope of protection. It will be readily understood that one of ordinary skill in the art may, according to the technical solution of the present invention, propose other alternative implementations without changing the essential spirit of the present invention. Therefore, the following particular embodiments and drawings are merely an illustrative description of the technical solution of the present invention and shall not be deemed as the entirety of the present invention or deemed as a definition or limitation of the technical solution of the present invention.

In the following description, for the sake of description, a direction where an elevator guide rail is located is defined as direction z, that is, an upward and downward direction, and a direction perpendicular to an operating surface of the elevator guide rail is defined as direction x, and a direction perpendicular to direction z and direction x is defined as direction y.

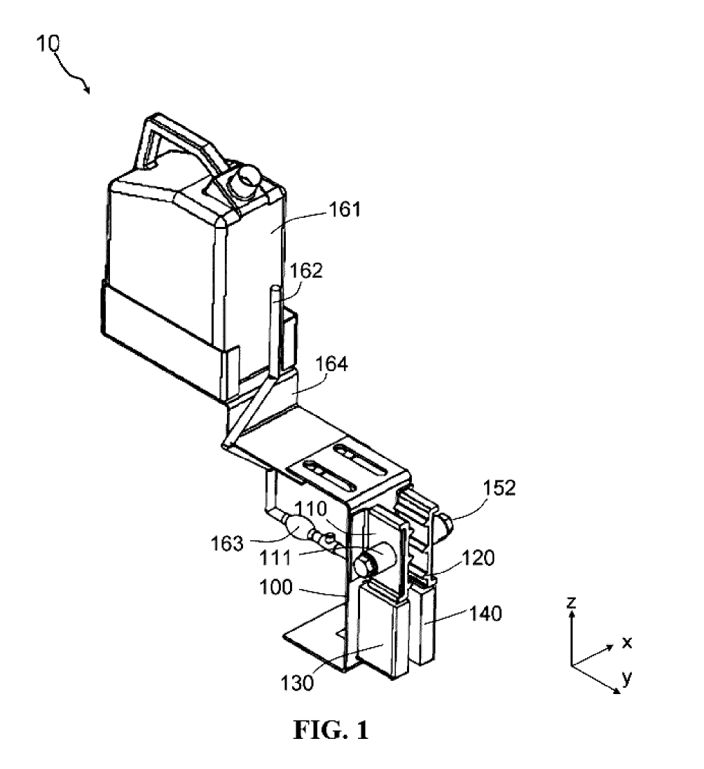

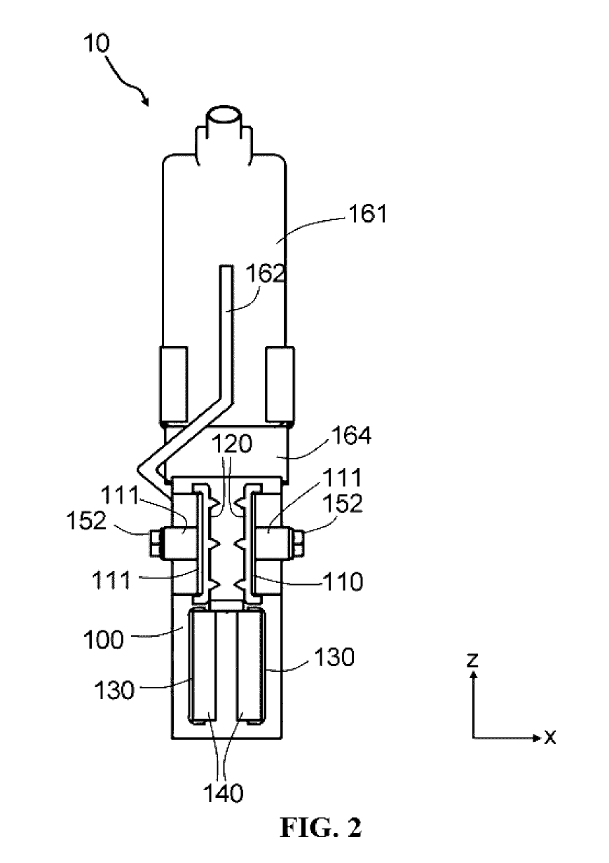

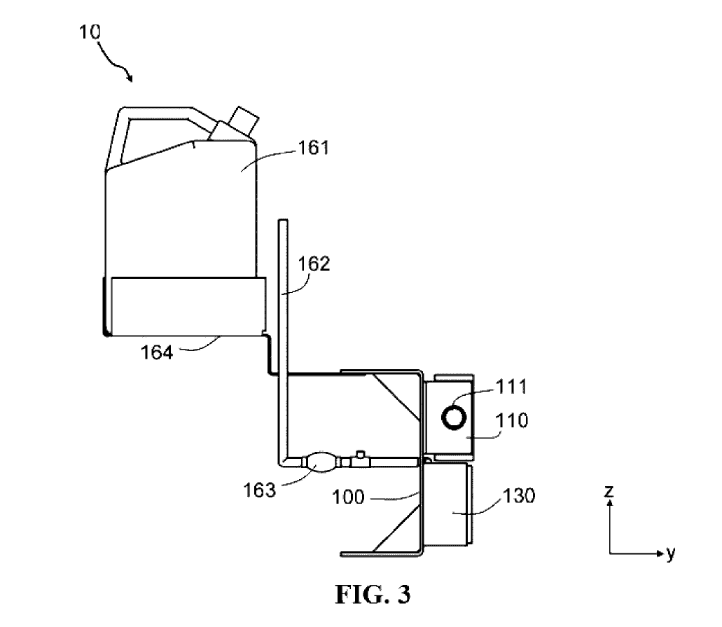

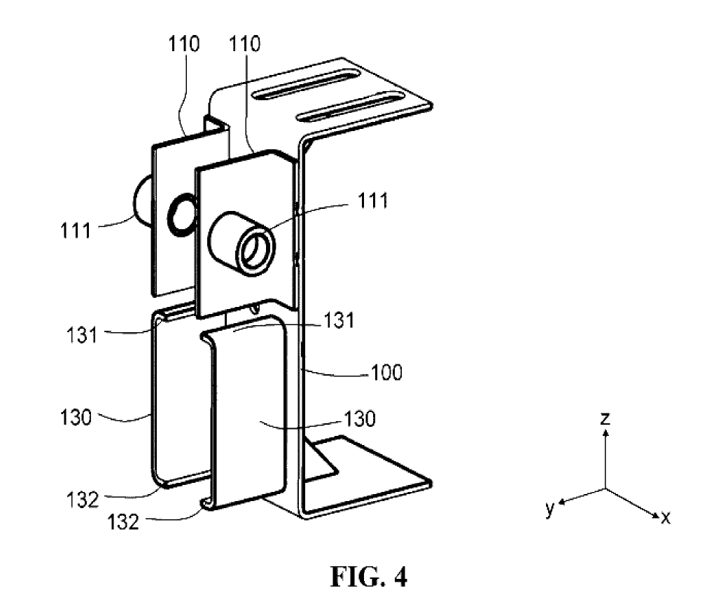

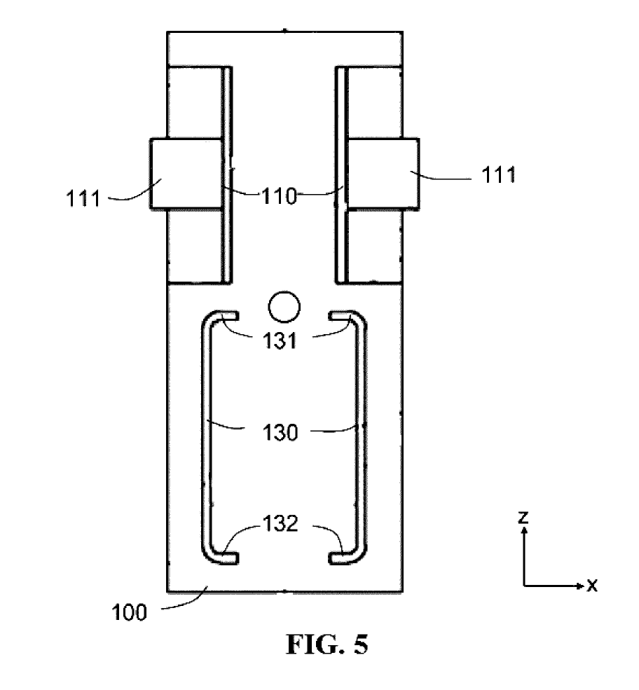

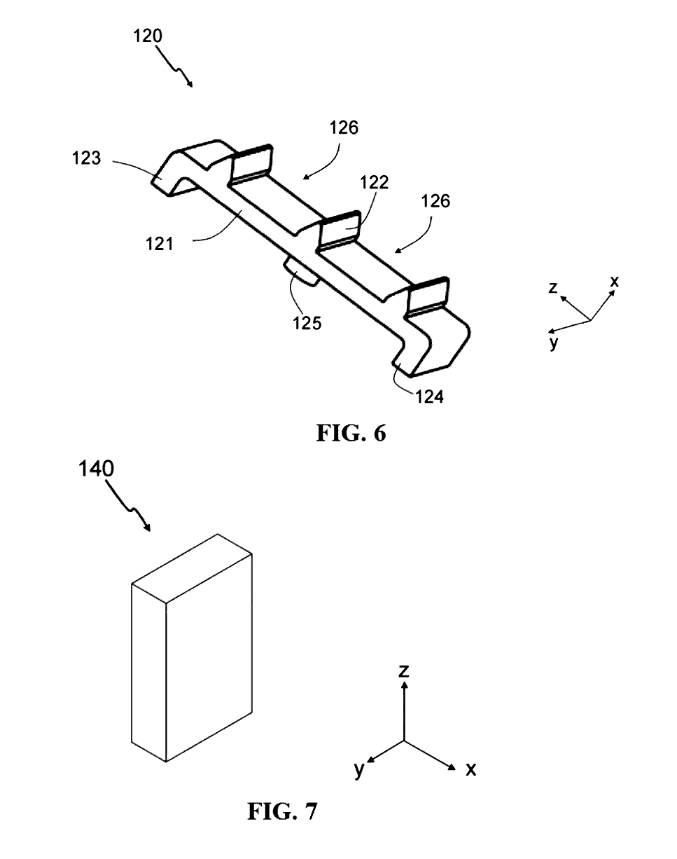

FIG. 1 is a perspective schematic structural diagram of an elevator guide rail cleaning apparatus according to an embodiment of the present invention. FIG. 2 is a front view of an elevator guide rail cleaning apparatus according to an embodiment of the present invention. FIG. 3 is a side view of an elevator guide rail cleaning apparatus according to an embodiment of the present invention. FIG. 4 is a perspective schematic structural diagram of a base body of the elevator guide rail cleaning apparatus shown in FIG. 1. FIG. 5 is a front view of the base body shown in FIG. 4. FIG. 6 is a perspective schematic structural diagram of a scraping component of the elevator guide rail cleaning apparatus shown in FIG. 1. FIG. 7 is a perspective schematic structural diagram of a wiping component of the elevator guide rail cleaning apparatus shown in FIG. 1. Hereinafter, the elevator guide rail cleaning apparatus according to an embodiment of the present invention and the scraping component and wiping component used thereby will be described in detail by way of example in conjunction with FIGS. 1 to 7.

An elevator guide rail cleaning apparatus 10 according to an embodiment of the present invention is used for cleaning an elevator guide rail 11 (as shown in FIG. 11). The particular type of the elevator guide rail is not limited. In particular, it can be a car guide rail and/or a counterweight guide rail used in a vertical elevator. The particular structure of the elevator guide rail is also not limited. For example, the elevator guide rail may be of a T shape, an L shape and so on. Although the elevator guide rail cleaning apparatus 10 according to an embodiment of the present invention is illustrated and described with respect to a certain type or a certain structure of elevator guide rail, it should be understood that a person skilled in the art may make adaptive designs and improvements according to the teaching and inspiration of the following embodiments of the present invention to apply to any other type or structure of elevator guide rail.

In particular, the elevator guide rail according to an example of the present invention is coated with anti-rust oil after leaving the factory to protect the operating surface of the elevator guide rail and prevent the same from rust. The anti-rust oil usually has relatively high viscosity and the anti-rust oil coating is also relatively thick and thus it is difficult to remove. The elevator guide rail cleaning apparatus 10 according to an embodiment of the present invention is exemplarily used to remove the anti-rust oil on the operating surface of the elevator guide rail.

As shown in FIGS. 1 to 5, the elevator guide rail cleaning apparatus 10 mainly includes a base 100. The base 100 is a body part of the elevator guide rail cleaning apparatus 10, through which the elevator guide rail cleaning apparatus 10 may be entirely installed on a guide apparatus of an elevator system, for example, installed on a guide shoe (as shown in FIG. 11) so as to move upwards and downwards synchronously with the guide shoe of the elevator system. In this example, the elevator system includes well-known components such as an elevator guide rail, a car, a guide shoe, safety tongs and so on. The guide shoe and the safety tongs are installed underneath the car and may operatively act on the operating surface of the elevator guide rail during operation.

In an embodiment, the elevator guide rail cleaning apparatus 10 also includes a scraping component 120 and/or a wiping component 140. In order to install the scraping component 120 opposite to the operating surface of the elevator guide rail, the base 100 is fixedly provided with a first installation part 110 and the scraping component 120 is detachably installed on the first installation part 110. In order to install the wiping component 140 opposite to the operating surface of the elevator guide rail, the base 100 is fixedly provided with a second installation part 130 and the wiping component 140 is detachably installed on the second installation part 130.

In order to cause the scraping component 120 to effectively scrape the anti-rust oil on the operating surface of the elevator guide rail, the elevator guide rail cleaning apparatus 10 is also provided with a pressure component which acts on the scraping component 120 so that the scraping component 120 can bias a certain action force on the operating surface of the elevator guide rail. The magnitude of the action force may be adjusted and set in particular depending on the cleaning effects of the anti-rust oil.

In the case where the operating surfaces of the elevator guide rail to be cleaned are two parallel operating surfaces, there are two scraping components 120 and two wiping components 140 respectively. Each scraping component 120/wiping component 140 is provided corresponding to one operating surface. Thus, the two scraping components 120 are installed opposite to each other in direction x and the two wiping component 140 are installed opposite to each other in direction x.

Referring to FIG. 6, in this embodiment, the scraping component 120 may be made of polyformaldehyde resin (POM) and integrally formed. POM can not only ensure the scraping and wiping intensity for the operating surface of the elevator guide rail but also has low costs and small scraping and wiping friction resistance. Thus, the cleaning and removing effects of the scraping component 120 for the anti-rust oil are good and the manufacture costs are low. However, it should be understood that the particular material of the scraping component 120 is not limited and it may be realized with any other similar materials.

Continue with FIG. 6, the integrally formed scraping component 120 includes a scraping plate 121 and a scraping bar 122. The scraping bar 122 is provided at one surface of the scraping plate 121 opposite to the operating surface of the elevator guide rail in a manner that the scraping bar 122 projects outwardly. Thus, under the action of the pressure component, the scraping bar 122 directly acts on the operating surface of the elevator guide rail and directly scrapes and removes the anti-rust oil. The number of the scraping bars 122 provided on the scraping plate 121 is not limited. For example, there may be three or more bars. A plurality of scraping bars 122 are provided in parallel in direction y. In this way, when the elevator guide rail cleaning apparatus 10 moves relative to the operating surface of the elevator guide rail in direction x, the scraping bars 122 may effectively remove the anti-rust oil.

The surface of the scraping plate 121 opposite to the operating surface of the elevator guide rail may be provided with a plurality of accommodation grooves 126. The accommodation groove 126 is provided between two adjacent scraping bars 122. In this way, the anti-rust oil scraped, by scraping bars 122, from the operating surface of the elevator guide rail may be at least partially accommodated in these accommodation grooves. A plurality of accommodation grooves may also be disposed in parallel in direction y. The width of the accommodation groove 126 is determined by a spacing between the scraping bars 122. The widths of the plurality of accommodation grooves 126 may be the same or different. Optionally, the width of the accommodation groove is in a range greater than or equal to 10 mm and smaller than or equal to 50 mm, such as 25 mm.

A particular thickness of the scraping plate 121 may be set particularly according to the type of the elevator guide rail. For example, the greater the distance between the operating surfaces of the elevator guide rails, the smaller the particular thickness of the scraping plate 121. In this way, in the case where the scraping component 120 can be installed detachably relative to the base 100, a corresponding thickness of the scraping plate 121 may be selected according to different elevator guide rail models or types.

Continue with FIG. 6, upper and lower ends of the scraping plate 121 flex toward a direction opposite to the projection direction of the scraping bar 122, forming an upper end part 123 and a lower end part 124. The back surface of the scraping plate 121 relative to the operating surface of the elevator guide rail is provided with a projection positioning part 125. As to the wiping component 120 in this embodiment, as shown in conjunction with FIGS. 4 and 5, the first installation part 110 provided on the base 100 in particular includes two installation plates provided perpendicular to the base 100 substantially in direction y. The installation plates may be fixed on the base 100 through welding or bolts. A back surface of each installation plate relative to the operating surface of the elevator guide rail is fixedly provided with a positioning cylinder 111. The pressure component in particular includes a spring (not shown) and a plug 152. The spring is compressively placed in the positioning cylinder 111. The plug 152 may be fixed on the positioning cylinder 111 by means of bolts. At the meantime, when the scraping component 120 is installed and fixed, the projection positioning part 125 of the scraping plate 121 aligns with the positioning cylinder 111 and is inserted into the positioning cylinder and snaps the upper and lower ends of the installation plate through the upper end part 123 and the lower end part 124 of the scraping plate 121. In this way, the scraping component 120 will not move relative to the first installation part 110 in direction z and it is convenient to detach the scraping component 120. At the meantime, during usage, one end of the spring applies a pressure on the projection positioning part 125 to further apply a pressure on the scraping component 120, and the other end of the spring is abutted by the plug 152 fixed on the positioning cylinder 111. In this way, when the plug 152 is fixed on the positioning cylinder 111 through threads, the amount of compression of the spring may be adjusted by twisting the plug 152 to conveniently adjust the action force applied to the scraping component 120.

It should be noted that the scraping component 120 may be designed correspondingly according to structural changes of the first installation part 110, the particular structure of which is not limited to the above embodiment.

The spring used in the pressure component may provide enough pressure to the scraping component 120 and is easy to adjust and set. In other alternative embodiments, however, the pressure component may be other elastic elements.

Referring to FIG. 7 and as shown in conjunction with FIGS. 1 to 3, in this embodiment, the wiping component 140 also directly acts on the operating surface of the elevator guide rail, and in particular acts on the operating surface of the elevator guide rail after being scraped by the scraping component 120. Although the scraping component 120 can effectively remove the anti-rust oil, some anti-rust oil may be left over inevitably, and the wiping component 140 is used to further remove the residual anti-rust oil. The wiping component 140 may be made of felt which has good cleaning effects and in particular it may be square-shaped. Correspondingly, the second installation part 130 on the base 100 in particular includes two installation plates provided perpendicular to the base 100 substantially in direction y. The installation plates may be fixed on the base 100 through welding or bolts and disposed in parallel in direction z. The upper end and the lower end of the installation plate flex toward the operating surface of the elevator guide rail to form an upper blocking part 131 and a lower blocking part 132. The square-shaped wiping component 140 is inserted between the upper blocking part 131 and the lower blocking part 132 and stopped thereby to prevent the wiping component 140 moving relative to the second installation part 130 in direction z. Moreover, it is convenient to detach and install the wiping component 140.

The thickness of the wiping component 140 in direction x may be set according to the particular elevator guide rail model or type. In the case where the distance between the two installation plates of the second installation part 130 (direction x) is determined, wiping components 140 with different thicknesses may be provided to correspond to different models or types of elevator guide rails.

Further, referring to FIGS. 1 to 3, a cleaning liquid supply apparatus corresponding to the wiping component 140 may be provided for supplying a cleaning liquid to the wiping component 140. The cleaning liquid may be a liquid which can dissolve the anti-rust oil. The wiping component 140 made of felt may store a certain volume of cleaning liquid with a similar effect to that of a sponge, so that the residual anti-rust oil may be dissolved effectively during cleaning and the cleaning effects and cleaning efficiency are improved greatly.

In an embodiment, the cleaning liquid supply apparatus mainly includes a cleaning liquid container 161, a liquid flow pipe 162 and a siphon component 163. An installation support 164 may be provided on the base 100 correspondingly for installing and fixing the cleaning liquid container 161. The cleaning liquid container 161 may be in particular located above the wiping component 140. One end of the liquid flow pipe 162 is inserted into the cleaning liquid container 161 and the other end is placed on the wiping component 140 for guiding the cleaning liquid in the cleaning liquid container 161 to the wiping component 140. The siphon component 163 is provided at one side of the liquid flow pipe 162 close to the wiping component 140. In this way, when the cleaning apparatus 10 prepares to carry out the cleaning work, the siphon component 163 may be pressed to guide the cleaning liquid in the cleaning liquid container 161 located above to the wiping component 140. The cleaning liquid supply apparatus in this embodiment supplies the cleaning liquid to the wiping component 140 continuously during cleaning based on siphon principles, the operation of which is simple and convenient and the effects are good.

In an embodiment, the elevator guide rail cleaning apparatus 10 is installed on the guide shoe underneath the car of the elevator system. The wiping component 140 is also located underneath the scraping component 120. Correspondingly, the second installation part 130 is provided underneath the first installation part. In this way, when the guide shoe moves upwards synchronously with the elevator guide rail cleaning apparatus 10 along the elevator guide rail, most or main anti-rust oil on the operating surface of the elevator guide rail is first scraped by the wiping component 120 and then the remaining anti-rust oil is cleaned and removed by the wiping component 140. The cleaning effects of the operating surface that is subjected to a scraping process and a wiping process successively are good.

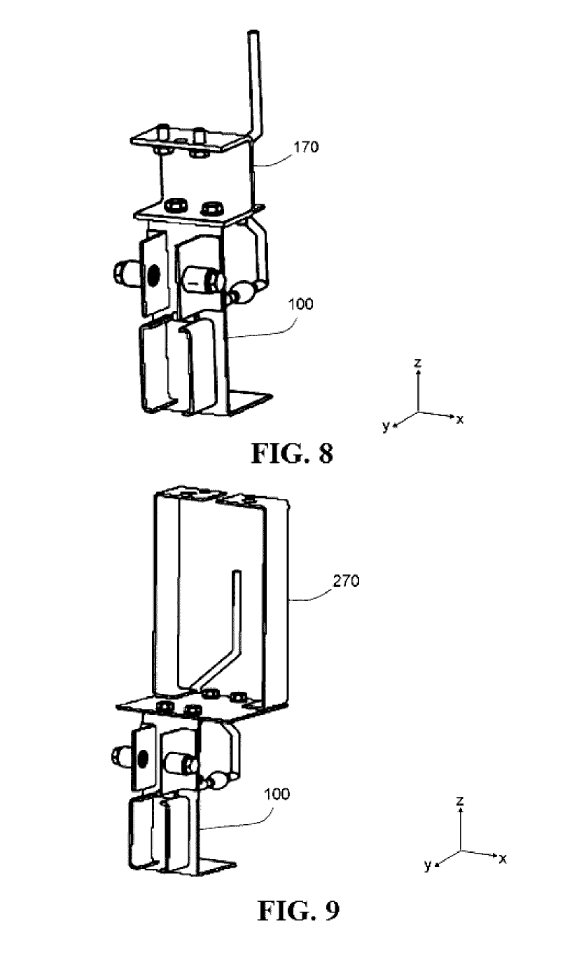

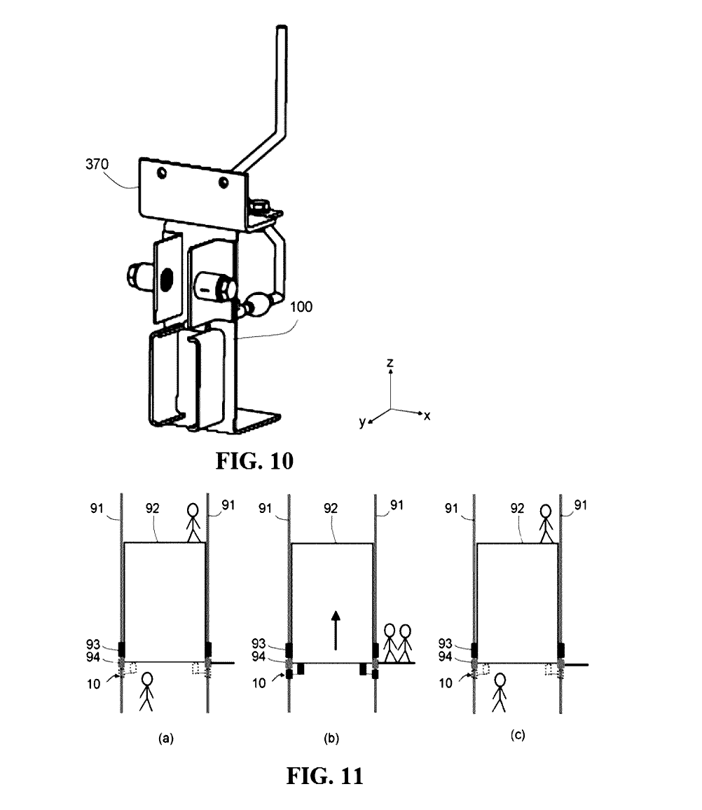

FIGS. 8 to 10 show installation supports in different examples where the elevator guide rail cleaning apparatus 10 may be applied. Through installation supports in different examples, the elevator guide rail cleaning apparatus 10 shown in FIGS. 1 to 3 may be installed on different types or models of guide shoes. In the structures shown in FIGS. 8 to 10, there is no scraping component 120, wiping component 140 and cleaning liquid supply apparatus installed on the base 100. In the example of FIG. 8, two installation surfaces of the installation support 170 are parallel to each other. The installation support may be fixed with a guide shoe by means of bolts through the upper installation surface and fixed with the base 100 by means of bolts through the lower installation surface. The installation support 170 in this example may be applied to guide shoes of models such as GeN2 CN-MR, GeN2 MRL, GeN2 CN-MRL and so on. In the example of FIG. 9, an installation support 270 is designed as a frame structure substantially, the upper end of which may be fixed with the guide shoe by means of bolts and the lower end may be fixed with the base 100 by means of bolts. The installation support 270 in this example may be applied to guide shoes of models such as GeN2 CN-MR, GeN2 MRL and so on. In the example of FIG. 10, an installation support 370 has an L-shaped cross section and two installation surfaces are perpendicular to each other. The installation support may be fixed with the guide shoe by means of bolts through the vertical installation surface and fixed with the base 100 by means of bolts through the horizontal installation surface. The installation support 370 in this example may be applied to guide shoes of models such as GeN2 CORE and so on. The installation supports 170, 270 and 370 are designed to be detachable relative to the base 100 of the elevator guide rail cleaning apparatus 10, which facilitates the entire installation and detachment of the elevator guide rail cleaning apparatus 10.

It should be noted that different shapes of installation supports may be correspondingly designed depending on the guide shoe structures used by different elevator systems.

FIG. 11 is a schematic process diagram of a cleaning method using an elevator guide rail cleaning apparatus according to an embodiment of the present invention. An elevator system includes an elevator guide rail 91 to be cleaned, a car 92, safety tongs 93 and a guide shoe 94. The car 92 may move upwards and downwards in direction z along the elevator guide rail 91. The guide rail 91 of the elevator system is coated with thick anti-rust oil and needs to be cleaned automatically through the elevator guide rail cleaning apparatus 10.

First, as shown in FIG. 11(a), a worker enters an elevator hoistway and manually installs the elevator guide rail cleaning apparatus 10 on the guide shoe 94 of the elevator system. In particular, the elevator guide rail cleaning apparatus 10 may be installed on the guide shoe 94 of the elevator system by using any installation support shown in FIGS. 8 to 10. And the cleaning liquid supply apparatus, the scraping component 120, and the wiping component 140 are installed. The siphon component 163 is pressed to supply a cleaning liquid to the wiping component 140. In particular, the pressure applied on the operating surface of the elevator guide rail 91 by the scraping component 120 may also be adjusted by adjusting the pressure component.

Furthermore, as shown in FIG. 11(b), the worker leaves the elevator system, and the elevator system operates so as to cause the elevator guide rail cleaning apparatus 10 and the guide shoe 94 to move upwards synchronously relative to the elevator guide rail 91. In this way, the scraping component 120 acts on the operating surface of the elevator guide rail 91 to scrape and remove the anti-rust oil on the operating surface of the elevator guide rail 91. At the meantime, the wiping component 140 acts on the operating surface of the elevator guide rail 91 subsequently to wipe the operating surface of the elevator guide rail 91. Through the scraping component 120, most of the highly viscous and thick anti-rust oil may effectively be removed, which facilitates the improvement of the removal efficiency, and the residual anti-rust oil may effectively be removed by the wiping component 140, which facilitates the improvement of the cleaning effects. The combination of the scraping component 120 and the wiping component 140 has advantages of high efficiency, good effects and automatic cleaning. In particular, the cleaning of substantially the entire elevator guide rail 91 may be realized by moving upwards along the elevator guide rail 91 from the lowermost part of the elevator hoistway, which has complete cleaning effects.

It should be noted that if one upward movement cannot effectively clean the guide rail, the above process may be repeated by controlling the elevator system. And, in the above process, the cleaning liquid supply apparatus may supply the cleaning liquid to the wiping component 140 continuously to dissolve the anti-rust oil on the operating surface of the elevator guide rail, which has better wiping effects.

Furthermore, as shown in FIG. 11(c), a worker enters an elevator hoistway and detaches and removes the elevator guide rail cleaning apparatus 10 from the guide shoe 94.

By then, the cleaning work of the elevator guide rail is completed and the anti-rust oil on the elevator guide rail is cleaned up. The elevator system may start normal operation.

It should be understood that the cleaning method shown in FIG. 11 may be performed during the installation of the elevator system for removing the anti-rust oil on the elevator guide rail after leaving the factory. And, the elevator guide rail cleaning apparatus 10 may be repeatedly applied to different elevators for cleaning process of an elevator guide rail. Before each cleaning process, the scraping component 120 and/or the wiping component 140 may or may not be replaced.

The above method for cleaning the elevator guide rail needs human intervention during the installation and detachment of the elevator guide rail cleaning apparatus 10, and thus it is basically completed automatically, which greatly reduces the labor intensity of the worker and has high cleaning efficiency and good cleaning effects.

It should be noted that, although the above examples are illustrated in terms of removing the anti-rust oil on the elevator guide rail by the elevator guide rail cleaning apparatus 10, it should be understood that the elevator guide rail cleaning apparatus 10 may also remove other foreign matters on the anti-rust oil on the elevator guide rail and the elevator guide rail cleaning apparatus 10 may also be applied to remove other foreign matters like anti-rust oil on the elevator guide rail.

The above examples mainly illustrate the elevator rail cleaning apparatus and cleaning method using the same, according to the present invention. Although only some embodiments of the present invention are illustrated, one of ordinary skill in the art shall understand that the present invention may be implemented in many other forms without departing from the gist and scope thereof. For example, the scraping bars 122 of the scraping component 120 are provided in a non-parallel fashion, the wiping component 140 is made of a nanometer sponge and so on. Therefore, the illustrated examples and embodiments are considered as illustrative rather than restrictive. Various modifications and replacements may be included in the present invention without departing from the spirit and scope of the present invention as defined in the appended claims.

1. An elevator guide rail cleaning apparatus (10), comprising:
a base (100);
a scraping component (120) installed opposite to an operating surface of an elevator guide rail; and
a wiping component (140) installed opposite to the operating surface of the elevator guide rail;
wherein the elevator guide rail cleaning apparatus (10) is detachably installed on a guide apparatus (94) of an elevator system.

2. The elevator guide rail cleaning apparatus (10) of claim 1, wherein the base (100) is provided with a first installation part (110) and a second installation part (130), the scraping component (120) is detachably installed on the first installation part (110), and the wiping component (140) is detachably installed on the second installation part (130).

3. The elevator guide rail cleaning apparatus (10) of claim 1, wherein the elevator guide rail cleaning apparatus (10) further comprises a pressure component for the scraping component (120) to bias a certain pressure to the operating surface of the elevator guide rail.

4. The elevator guide rail cleaning apparatus (10) of claim 3, wherein the pressure component includes a spring and a plug (152), wherein the spring is placed in a positioning cylinder (111) provided on the first installation part (110) and causes a first end of the spring to apply a pressure to the scraping component (120) and a second end of the spring to abut the plug (152) fixed on the positioning cylinder (111).

5. The elevator guide rail cleaning apparatus (10) of claim 1, wherein the scraping component (120) is mainly made of polyformaldehyde resin (POM) and integrally formed.

6. The elevator guide rail cleaning apparatus (10) of claim 1, wherein the scraping component (120) includes a scraping plate (121) and a scraping bar (122) provided on the scraping plate (121) in a projection manner.

7. The elevator guide rail cleaning apparatus (10) of claim 6, wherein there are three or more scraping bars (122) and a plurality of scraping bars (122) are disposed perpendicular to a length direction of the elevator guide rail.

8. The elevator guide rail cleaning apparatus (10) of claim 7, wherein an operating surface of the scraping plate (121) is provided with a plurality of accommodation grooves.

9. The elevator guide rail cleaning apparatus (10) of claim 8, wherein each of the accommodation grooves is provided between adjacent scraping bars (122).

10. The elevator guide rail cleaning apparatus (10) of claim 9, wherein the width of the accommodation groove is 10 mm to 50 mm.

11. The elevator guide rail cleaning apparatus (10) of claim 1, wherein there are two scraping components (120) and the two scraping components (120) are installed opposite to each other.

12. The elevator guide rail cleaning apparatus (10) of claim 1, wherein the wiping component (140) is mainly made of felt.

13. The elevator guide rail cleaning apparatus (10) of claim 1, wherein the wiping component (140) is square-shaped.

14. The elevator guide rail cleaning apparatus (10) of claim 1, wherein there are two wiping components (140) and the two wiping components (140) are installed opposite to each other.

15. The elevator guide rail cleaning apparatus (10) of claim 1, wherein the elevator guide rail cleaning apparatus (10) further comprises a cleaning liquid supply apparatus for supplying a cleaning liquid to the wiping component (140).

16. The elevator guide rail cleaning apparatus (10) of claim 15, wherein the cleaning liquid supply apparatus includes:
a cleaning liquid container (161) fixed on the base (100) and located above the wiping component (140);
a liquid flow pipe (162) for guiding the cleaning liquid in the cleaning liquid container (161) to the wiping component (140); and
a siphon component (163) provided at one side of the liquid flow pipe (162) close to the wiping component (140).

17. The elevator guide rail cleaning apparatus (10) of claim 1, wherein the guide apparatus is a guide shoe (94) installed underneath a car (92) of the elevator system.

18. The elevator guide rail cleaning apparatus (10) of claim 17, wherein the wiping component (140) is located underneath the scraping component (120).

19. The elevator guide rail cleaning apparatus (10) of claim 17, wherein the elevator guide rail cleaning apparatus (10) further comprises installation supports (170, 270, 370) for detachably installing the base (110) on the guide shoe.

20. A method for cleaning an elevator guide rail by using the elevator guide rail cleaning apparatus (10) of claim 1, comprising the following steps:
step 1: installing the elevator guide rail cleaning apparatus (10) on a guide apparatus of an elevator system;
step 2: running the elevator system to cause the elevator guide rail cleaning apparatus (10) and the guide apparatus to move synchronously relative to the elevator guide rail, cause the scraping component (120) to scrape and remove an anti-rust coating on an operating surface of the elevator guide rail, and cause the wiping component (140) to wipe the operating surface of the elevator guide rail; and
step 3: detaching and removing the elevator guide rail cleaning apparatus (10).

21. The method of claim 20, wherein in step 2, a cleaning liquid is supplied to the wiping component (140) to dissolve the anti-rust coating.

22. The method of claim 20, wherein in step 2, the guide apparatus moves upwards from the bottom of an elevator hoistway.

23. The method of claim 20, wherein the method for cleaning an elevator guide rail is carried out during the installation of the elevator system.

24. A scraping component (120) used in the elevator guide rail cleaning apparatus (10) of claim 1.

25. A wiping component (140) used in the elevator guide rail cleaning apparatus (10) of claim 1.
